(19) United States
(12) Patent Application Publication
(10) Pub. No.: US 2026/0278674 A1
(43) Pub. Date: Sep. 17, 2026

(54) INFORMATION PROCESSING DEVICE AND METHOD, AND PROGRAM

(71) Applicant: SONY FINANCIAL GROUP INC., Tokyo (JP)

(72) Inventor: Kaya KANAMORI, Tokyo (JP)

(73) Assignee: SONY FINANCIAL GROUP INC., Tokyo (JP)

(21) Appl. No.: 19/474,003

(22) PCT Filed: Dec. 22, 2023
(86) PCT No.: PCT/JP2023/046089

§ 371 Date: Oct. 9, 2025

(30) Foreign Application Priority Data
Apr. 13, 2023 (JP) 2023-065313

(51) Int. Cl. G06Q 40/02; G06F 3/04817; G06F 3/0482; G06F 3/04842; G06Q 20/10; G06Q 20/36; G06Q 20/40

(52) U.S. Cl. CPC G06Q 40/026; G06F 3/04817; G06F 3/0482; G06F 3/04842; G06Q 20/10; G06Q 20/363; G06Q 20/4014; G06Q 20/407

(57) ABSTRACT

The present technology relates to an information processing device and method, and a program that make it possible to improve convenience. An information processing device includes: a recording unit that links account information of one or a plurality of private bank accounts of a user with address information of one or a plurality of noncustodial wallets of the user and records the information; and a control unit that switches, based on the account information and the address information, according to operation of the user, display of a private bank account screen on which information concerning the private bank account is displayed, a wallet screen on which information concerning the noncustodial wallet is displayed, and a home screen on which information concerning the one or the plurality of private bank accounts and information concerning the one or the plurality of noncustodial wallets can be displayed. The present technology is applicable to an information processing device.

### TECHNICAL FIELD

The present technology relates to an information processing device and method, and a program and, more particularly, relates to an information processing device and method, and a program that make it possible to improve convenience.

### BACKGROUND ART

In recent years, users who use services in the metaverse, Web 3.0, and the like based on a blockchain have been increasing.

When using such services, it is conceivable that a user properly uses a plurality of wallets and a plurality of private bank accounts for each of the services and the like. In future, it is assumed that needs concerning the proper use of such wallets and the like will increase.

As a technology concerning wallets, a technology for preventing leakage of a secret key has also been proposed (for example, Patent Literature 1).

### CITATION LIST

### Patent Literature

Patent Literature 1: International Publication No. WO 2020/049951

### SUMMARY OF INVENTION

### Technical Problem

Incidentally, in the current situation, for example, in provision of various services, it is not particularly considered that a user owns a plurality of wallets or bank accounts. For that reason, there has been a demand for a technology for utilizing a plurality of wallets or bank accounts without causing a user to feel inconvenience.

The present technology has been devised in view of such a situation and makes it possible to improve convenience.

### Solution to Problem

An information processing device according to a first aspect of the present technology includes: a recording unit that links account information of one or a plurality of private bank accounts of a user with address information of one or a plurality of noncustodial wallets of the user and records the account information and the address information; and a control unit that switches, based on the account information and the address information, according to operation of the user, display of a private bank account screen on which information concerning the private bank account is displayed, a wallet screen on which information concerning the noncustodial wallet is displayed, and a home screen on which information concerning the one or the plurality of private bank accounts and information concerning the one or the plurality of noncustodial wallets can be displayed.

An information processing method or a program according to the first aspect of the present technology includes a step of switching, based on account information of one or a plurality of private bank accounts of a user and address information of one or a plurality of noncustodial wallets of the user, the account information and the address information being linked with each other and recorded, according to operation of the user, display of a private bank account screen on which information concerning the private bank account is displayed, a wallet screen on which information concerning the noncustodial wallet is displayed, and a home screen on which information concerning the one or the plurality of private bank accounts and information concerning the one or the plurality of noncustodial wallets can be displayed.

In the first aspect of the present technology, based on account information of one or a plurality of private bank accounts of a user and address information of one or a plurality of noncustodial wallets of the user, the account information and the address information being linked with each other and recorded, according to operation of the user, display of a private bank account screen on which information concerning the private bank account is displayed, a wallet screen on which information concerning the noncustodial wallet is displayed, and a home screen on which information concerning the one or the plurality of private bank accounts and information concerning the one or the plurality of noncustodial wallets can be displayed are switched.

An information processing device according to a second aspect of the present technology includes a control unit that, based on account information of one or a plurality of private bank accounts of a user and address information of one or a plurality of noncustodial wallets of the user, the account information and the address information being linked with each other and recorded, displays a home screen on which information concerning the one or the plurality of private bank accounts and information concerning the one or the plurality of noncustodial wallets can be displayed and switches, according to operation of the user, whether to display information concerning one of the private bank accounts on the home screen, display information concerning one of the noncustodial wallets on the home screen, or display information concerning total assets of the private bank account and the noncustodial wallet on the home screen.

An information processing method or a program according to the second aspect of the present technology includes a step of, based on account information of one or a plurality of private bank accounts of a user and address information of one or a plurality of noncustodial wallets of the user, the account information and the address information being linked with each other and recorded, displaying a home screen on which information concerning the one or the plurality of private bank accounts and information concerning the one or the plurality of noncustodial wallets can be displayed and switching, according to operation of the user, whether to display information concerning one of the private bank accounts on the home screen, display information concerning one of the noncustodial wallets on the home screen, or display information concerning total assets of the private bank accounts and the noncustodial wallets on the home screen.

In the second aspect of the present technology, based on account information of one or a plurality of private bank accounts of a user and address information of one or a plurality of noncustodial wallets of the user, the account information and the address information being linked with each other and recorded, a home screen on which information concerning the one or the plurality of private bank accounts and information concerning the one or the plurality of noncustodial wallets can be displayed is displayed and, according to operation of the user, whether to display information concerning one of the private bank accounts on the home screen, display information concerning one of the noncustodial wallets on the home screen, or ; display information concerning total assets of the private bank accounts and the noncustodial wallets on the home screen is switched.

### BRIEF DESCRIPTION OF DRAWINGS

FIG. 1 is a diagram illustrating a configuration example of an information processing system.

FIG. 2 is a diagram illustrating a display screen example.

FIG. 3 is a diagram illustrating a display screen example.

FIG. 4 is a diagram illustrating a display screen example.

FIG. 5 is a diagram illustrating a display screen example.

FIG. 6 is a diagram illustrating a display screen example.

FIG. 7 is a diagram illustrating a display screen example.

FIG. 8 is a diagram illustrating a display screen example.

FIG. 9 is a diagram illustrating a display screen example.

FIG. 10 is a diagram illustrating a display screen example.

FIG. 11 is a diagram illustrating a display screen example.

FIG. 12 is a flowchart for explaining display processing.

FIG. 13 is a diagram illustrating a configuration example of a computer.

### DESCRIPTION OF EMBODIMENT

An embodiment to which the present technology is applied is explained below with reference to the drawings.

### First Embodiment

### Configuration of an Information Processing System

The present technology makes it possible to improve convenience by easily switching display of a screen of a private bank account managed by a custodial wallet, a screen of a noncustodial wallet, and a home screen including information concerning both of the private bank account and the noncustodial wallet. In this case, a wallet to be used can also be switched simultaneously with the switching of the display of the screens.

The private bank account is a bank account that can be used after identity verification by KYC (Know Your Customer) or the like. A custodial wallet, a secret key of which is managed on a service side, is used for processing such as deposit and withdrawal, remittance, and the like in which the private bank account is used. That is, the private bank account is managed by the custodial wallet.

A user is capable of using a service such as transaction of legal currencies and crypto assets and performing purchase, management, and the like of an NET (Non-Fungible Token) by using an identity-verified private bank account (custodial wallet).

The private bank account (the custodial wallet) is used in a service that uses a centralized management type database or a private blockchain that only a specific user can use. Note that the custodial wallet indicates a wallet in which a third party (for example, a company that provides the service) keeps a secret key in place of a user. In addition, the private bank account may be managed by not only the centralized management type database and the block chain but also any other method such as any method that uses a distributed ledger technology (DLT).

In contrast, the noncustodial wallet is a wallet, a secret key of which is locally managed by the user.

The noncustodial wallet is used in a service that uses a public blockchain (a public chain) in which any user can participate.

Note that, in the following explanation, a noncustodial wallet created by the user for each purpose such as use of a service in the metaverse or Web 3.0 is referred to as public wallet as well.

The user is capable of performing management and transaction of a crypto asset and perform purchase, management, and the like of an NFT using the noncustodial wallet (the public wallet).

The NFT referred to herein is, for example, content (an NFT item) based on media data to which an ownership certificate is imparted. For example, the media data is digital data of content such as a moving image or a still image, sound, or 3D data. In the following explanation, the NFT item, which is the content with the ownership certificate and the like, is simply referred to as NFT. Note that the NET item (the NFT) is not limited to the content and may be anything such as various certificates such as a participation certificate of an event and memberships.

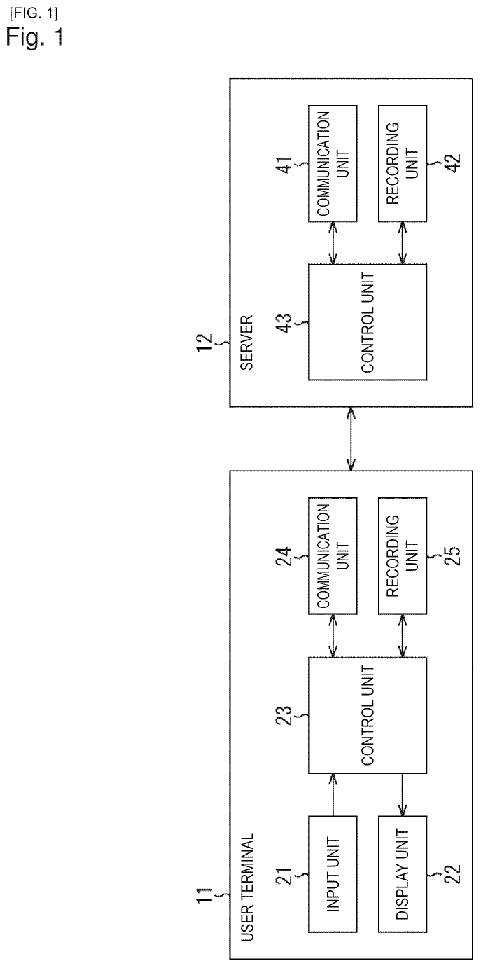

FIG. 1 is a diagram illustrating a configuration example of an embodiment of an information processing system to which the present technology is applied.

The information processing system illustrated in FIG. 1 includes a user terminal 11 and a server 12. The user terminal 11 and the server 12 are connected to each other via any network such as the Internet.

The user terminal 11 is an information processing device such as a smartphone, a tablet terminal, or a personal computer owned by a user. For example, the user terminal 11 manages a secret key of a public wallet (a noncustodial wallet) of the user.

In addition, the server 12 is an information processing device managed by a company that manages a private bank account of the user and provides services such as a crypto asset transaction in which the private bank account is used. For example, the server 12 manages a secret key of a custodial wallet of the user.

The user terminal 11 includes an input unit 21, a display unit 22, a control unit 23, a communication unit 24, and a recording unit 25.

The input unit 21 includes buttons, switches, and a touch panel provided to be superimposed on the display unit 22 and supplies a signal corresponding to operation of the user to the control unit 23.

The display unit 22 displays, according to an instruction of the control unit 23, any image such as a screen of a wallet application that implements a service in which one or a plurality of public wallets and an identity-verified private bank account (custodial wallet) are associated.

The wallet application is also considered to be an application for using, while switching as appropriate, a plurality of accounts used by the user such as an account of the user corresponding to the public wallet and an account corresponding to the private bank account.

The control unit 23 controls an operation of the entire user terminal 11.

For example, the control unit 23 performs management of the public wallet (the noncustodial wallet) of the user, processing concerning association of the public wallet and the private bank account, and the like.

In addition, for example, the control unit 23 generates a secret key of the public wallet based on a predetermined random number or the like and supplies the generated secret key to the recording unit 25 and causes the recording unit 25 to record the secret key and manages address information and NFT information of the public wallet recorded in the recording unit 25.

The NFT information referred to herein is information concerning an NFT owned by an account concerning the public wallet of the user. Specifically, for example, the NFT information is considered to be a contract address, a token name, a metadata URL (Uniform Resource Locator), owner information, media data, and the like.

The contract address is an address on a blockchain in which a smart contract for managing the NET is arranged. The token name is a name representing the NFT. In addition, the metadata URL is information indicating an acquisition destination of metadata. The metadata is a data file of a predetermined format such as a JSON (JavaScript Object Notation) format in which explanation of the NFT, a reference destination (a URL) of media data, and the like are described. The owner information is address information indicating a wallet address that owns the NFT.

The communication unit 24 communicates with the server 12 via a network such as the Internet. The recording unit 25 records information supplied from the control unit 23 and supplies the recorded information to the control unit 23.

For example, any information such as information concerning the wallet application is recorded in the recording unit 25. Specifically, for example, connection destination information for connecting to the server 12 such as a URL or an IP (Internet Protocol) address, connection destination information for connecting to an external server that provides any service, and the like are recorded in the recording unit 25.

In addition, address information and a secret key of the public wallet used in one or a plurality of accounts, account information of the public wallet, account information of the private bank account, and the like are also recorded in the recording unit 25.

For example, the account information of the private bank account includes information such as an account ID of the user in the server 12, that is, an account ID and an account name of the private bank account. The account ID of the user in the server 12 is identification information for uniquely identifying the user in a service provided by the server 12. Similarly, the account information of the public wallet includes information such as an account ID and an account name of the user concerning the public wallet.

In the recording unit 25, account information of the user concerning the private bank account and address information of the custodial wallet managed by the server 12 and address information and account information of the one or the plurality of public wallets are linked and managed (recorded).

Accordingly, custodial wallets (private bank accounts) and public wallets of different accounts of the same user are in an associated state. For that reason, the user can switch wallets such as a public wallet and a custodial wallet with simple operation.

The server 12 includes a communication unit 41, a recording unit 42, and a control unit 43.

The communication unit 41 communicates with the user terminal 11 via a network such as the Internet.

The recording unit 42 records any information such as information concerning the wallet application. For example, information concerning a crypto asset transaction service is recorded in the recording unit 42.

Here, the information concerning the crypto asset transaction service is, for example, account information such as an account ID, an account name, and a password of the user in the crypto asset transaction service, that is, account information of the private bank account.

Besides, as the information concerning the crypto asset transaction service, address information and a secret key of a custodial wallet used in the crypto asset transaction service, user information used for identity verification at the time of bank account opening in the crypto asset transaction service, and the like are also recorded. For example, user information subjected to identity verification (subjected to KYC) includes information concerning a user individual such as a name, an age, an address, and a telephone number of the user.

The control unit 43 controls an operation of the entire server 12. For example, the control unit 43 manages the private bank account, that is, the custodial wallet of the user.

That is, for example, the control unit 43 generates a secret key of the custodial wallet based on a predetermined random number or the like and supplies the generated secret key to the recording unit 42 and causes the recording unit 42 to record the secret key and manages address information, user information, and account information of the custodial wallet recorded in the recording unit 42.

### Display Screen Example

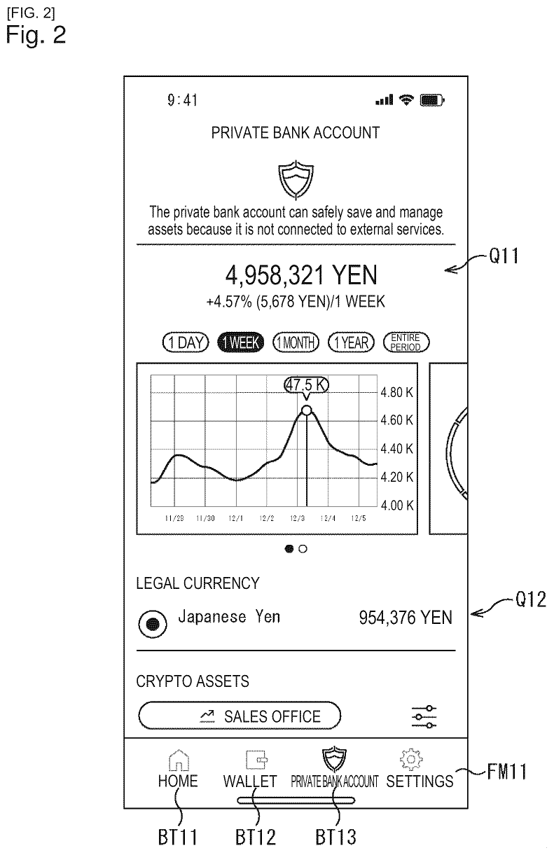

Examples of display screens of the wallet application displayed on the user terminal 11 are explained with reference to FIG. 2 to FIG. 11.

The display screens illustrated in FIG. 2 to FIG. 11 are screens that the control unit 23 causes the display unit 22 to display according to signals supplied from the input unit 21 to the control unit 23 according to operation on the input unit 21 by the user. Note that, in FIG. 2 to FIG. 11, portions corresponding to each other are denoted by the same reference numerals and signs and explanation of the portions is omitted as appropriate.

FIG. 2 illustrates an example of a private bank account screen on which information concerning the private bank account, in particular, information concerning assets held in the private bank account is displayed. On the private bank account screen, basically, information concerning the public wallet is not displayed and only the information concerning the private bank account is displayed.

In the example illustrated in FIG. 2, a total amount of assets managed by the private bank account (the custodial wallet), a chart of increases and decreases of the assets, and the like are displayed in a portion indicated by an arrow Q11 on the private bank account screen. The asset total amount referred to herein is, for example, a total amount of legal currencies and crypto assets held in the private bank account.

A deposit amount of a legal currency such as Japanese yen of the user managed by the private bank account is displayed in a portion indicated by an arrow Q12. Further, the user can also cause to be displayed, by performing scroll operation on the private bank account screen, information concerning a crypto asset such as an amount held of a crypto asset of the user managed by the private bank account, information concerning an NFT managed by the private bank account (the custodial wallet), and the like.

Note that, on a display screen of the wallet application such as the private bank account screen, as the information concerning the NFT, one or both of information concerning the NFT in an OFF chain state and information concerning the NFT in an ON chain state can be displayed.

The OFF chain state is a state in which an NFT (data) is not recorded in the blockchain yet. The ON chain state is a state in which an NFT is recorded in the blockchain. Note that, in the following explanation, an example in which an NFT is recorded in the blockchain is explained. However, not only this, but a recording destination of the NFT only has to be a P2P database or the like that is a distributed file system in which a P2P (Peer to Peer) network is used.

A footer menu FM11 is displayed on a screen in the example illustrated in FIG. 2. The footer menu FM11 is a menu display region always (regularly) displayed on the display screen of the wallet application basically not being limited on the private bank account screen.

For example, it is assumed that operation by the user is performed on the screen on which the footer menu FM11 is displayed and a new screen is popup-displayed in the front of the screen. In such a case, the footer menu FM11 is sometimes not displayed on the popup-displayed new screen. However, the footer menu FM11 is kept displayed on the screen displayed under the new screen.

Note that an example in which the footer menu FM11 is always displayed explained here. However, the display of the footer menu FM11 may be able to be hidden (not displayed) by swipe operation or the like or the footer menu FM11 may change to a non-display state after being displayed for a predetermined time. Further, the footer menu FM11 in the non-display state may be able to be easily displayed by swipe operation or the like.

In the footer menu FM11, a home button BT11 for causing a home screen to be displayed, a wallet button BT12 for causing a public wallet screen to be displayed, and a private bank account button BT13 for causing a private bank account screen to be displayed are provided. Besides, setting buttons for performing various kinds of setting are also provided in the footer menu FM11.

When the home button BT11 is operated by the user, the display screen of the wallet application is switched to the home screen.

The home screen is a screen on which information concerning the private bank account of the user and information concerning the one or the plurality of public wallets of the user can be displayed. In other words, the home screen is a screen on which both of the information concerning the private bank account and the information concerning the public wallets are displayed (can be displayed).

When the wallet button BT12 is operated by the user, the display screen of the wallet application is switched to the public wallet screen.

The public wallet screen is a screen on which information concerning the public wallet, in particular, information concerning an asset held in the public wallet is displayed. On the public wallet screen, basically, the information concerning the private bank account is not displayed and only the information concerning the public wallet is displayed.

When the private bank account button BT13 is operated by the user, the display screen of the wallet application is switched to the private bank account screen.

In the example illustrated in FIG. 2, the private bank account button BT13 is in a selected state, that is, the private bank account button BT13 is in an activated state and the private bank account screen is displayed as the display screen.

Note that, in the following explanation, an example in which one private bank account of the user and one or a plurality of public wallets are associated is explained. However, not only this, but a plurality of identity-verified private bank accounts of the user and one or a plurality of public wallets may be associated (linked). In such a case, by performing operation on a switching button, a private bank account list, or the like provided on the private bank account screen or the like, the user can select one private bank account out of the plurality of private bank accounts and cause information concerning the selected private bank account to be displayed on the private bank account screen.

Information concerning the plurality of private bank accounts can be displayed on the home screen as well.

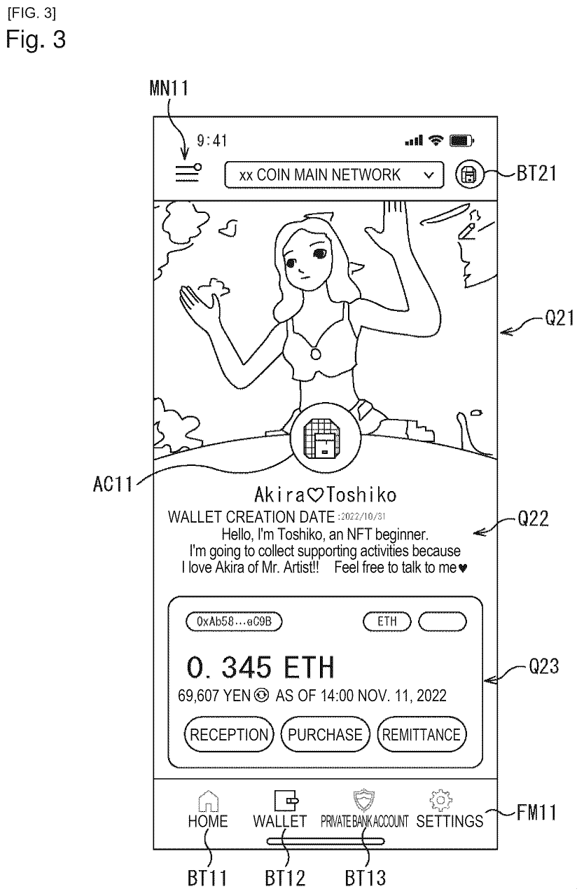

FIG. 3 illustrates an example of the public wallet screen.

In this example, a menu button MN11 and a switching button BT21 are displayed on the public wallet screen.

For example, the user can operate the menu button MN11 to cause a menu to be displayed and, by performing operation on the menu, cause various kinds of processing in which a public wallet is used to be executed, such as connecting to a Web site of a desired service with the public wallet.

By operating the switching button BT21, the user can select a desired public wallet out of the one or the plurality of public wallets. Information concerning the public wallet selected by the user is displayed on the public wallet screen. Note that, in the following explanation, the public wallet in a state of being selected by the user is particularly referred to as selected-state public wallet as well.

Any image such as an NFT selected by the user is displayed in a portion indicated by an arrow Q21 on the public wallet screen.

As information concerning one public wallet in a selected state, an account name of the public wallet, text information such as self-introduction concerning an account, an icon image AC11, and the like are displayed in a portion indicated by an arrow Q22.

For example, the icon image AC11 is an image representing the account of the public wallet. Here, the icon image AC11 is an image of a character expressing the account.

The icon image AC11 corresponding to the public wallet may be any image such as an image of an NFT managed by the public wallet. As an example, for example, the user can select, as the icon image AC11, an image for an icon (an NFT for an icon) called PFP (Profile Photo) or the like.

Personality (identity) can be formed in the public wallet by the icon image AC11, the text information, and the like displayed in the portion indicated by the arrow Q22. That is, identity expression for expressing the public wallet as if the public wallet is one character having personality can be performed by information presentation such as the icon image AC11.

Information concerning a crypto asset held in the public wallet in the selected state is displayed in a portion indicated by an arrow Q23 on the public wallet screen. In this example, besides the information such as an amount held, a reception button, a purchase button, a remittance button, and the like are also provided. Reception, purchase, remittance, and the like of a crypto asset can also be performed.

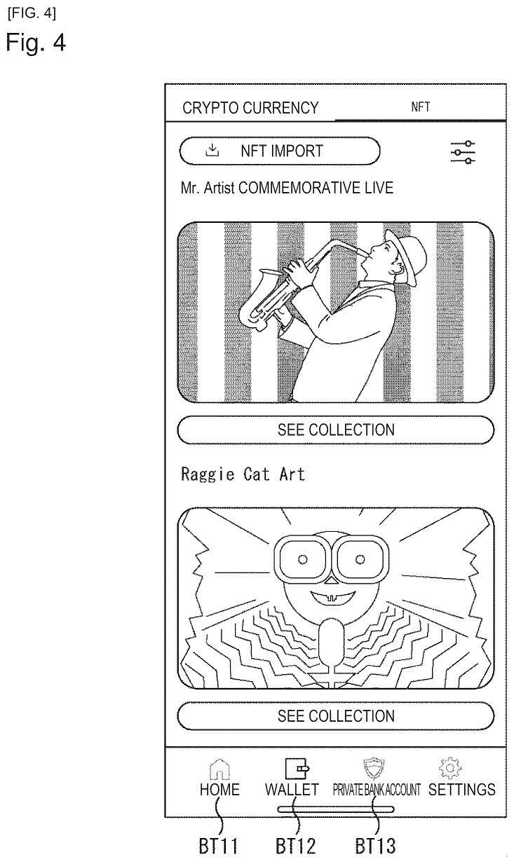

Further, when the user performs scroll operation on the public wallet screen in the state illustrated in FIG. 3, for example, as illustrated in FIG. 4, information concerning an NFT (NFT information) owned by the public wallet in the selected state is displayed on the public wallet screen. Accordingly, the user can view a collection of NFTs held by the user.

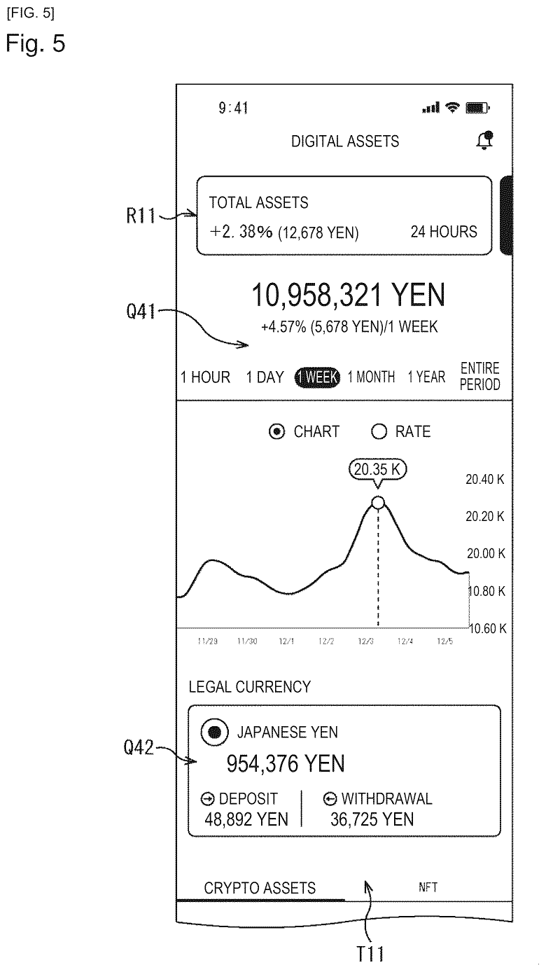

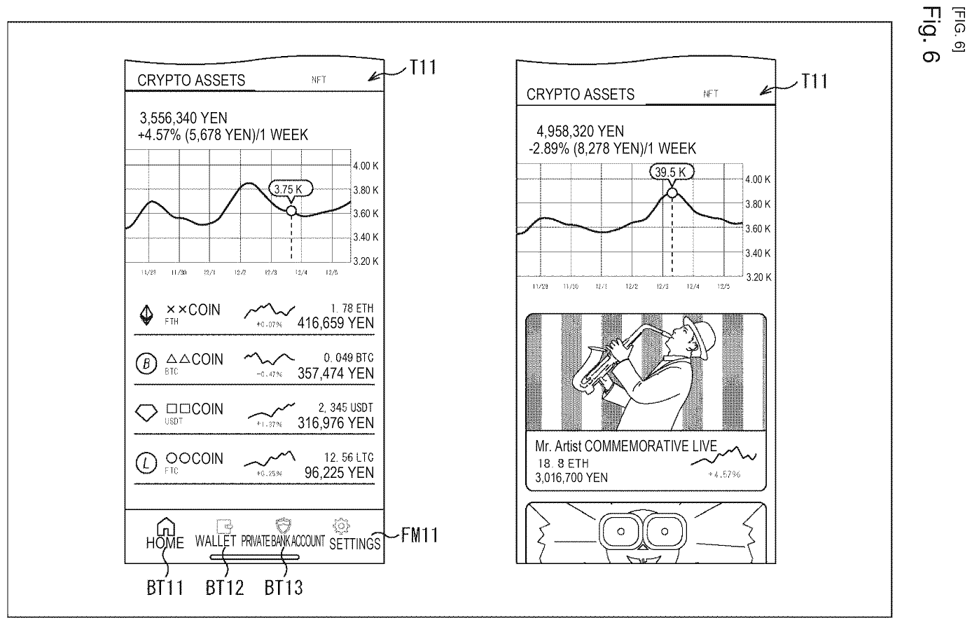

Examples of the home screen are illustrated in FIG. 5 and FIG. 6. Note that FIG. 6 is an example of a screen following the lower side in FIG. 5 of the screen illustrated in FIG. 5.

As illustrated in FIG. 5, a slide region R11 for selecting information to be displayed on the home screen by slide operation is provided in an upper part of the home screen. For example, the slide region R11 can be always (regularly) displayed on the home screen.

By performing the slide operation (swipe operation) on the slide region R11, the user can select (switch) information concerning total assets, information concerning a private bank account, and information concerning a public wallet as the information to be displayed on the home screen. That is, any one of the total assets, the private bank account, and the public wallet can be selected in the slide region R11.

Here, the information concerning the total assets is information concerning a total of assets held in all wallets held by the user including the private bank account (the custodial wallet) and the public wallet of the user. The assets held by the user include at least legal currencies, crypto assets, and NFTs.

When there are a plurality of public wallets held by the user, in the slide region R11, any one of the plurality of public wallets can be selected. For example, when the user performs the slide operation on the slide region R11 in a state in which a predetermined public wallet is selected in the slide region R11, another public wallet different from the predetermined public wallet is selected.

In the example illustrated in FIG. 5, “total assets” is selected in the slide region R11. An amount of the total assets and an increase or decrease amount of the total assets of the user are displayed in the slide region R11.

Since “total assets” is selected in the slide region R11 in this example, in FIG. 5 and FIG. 6, information concerning the selected total assets is displayed on the home screen.

That is, in a portion indicated by an arrow Q41 in the home screen, a total asset amount obtained by converting the total assets of the user into Japanese yen and a chart indicating increases and decreases in the total asset amount are displayed. Information concerning a legal currency (Japanese yen) in the total assets of the user is displayed in a portion indicated by an arrow Q42.

Further, on a lower side of the portion indicated by the arrow Q42, a tab T11 for switching which information of information concerning a crypto asset and information concerning an NFT should be displayed is provided.

When the “crypto asset” is selected in the tab T11, for example, a screen illustrated on the left side of FIG. 6 is displayed on the home screen.

In this example, information concerning a crypto asset in the total assets of the user is displayed on the home screen. Specifically, an amount obtained by converting a total amount of crypto assets held by the user into a legal currency (Japanese yen) and a chart indicating increases and decreases in the converted amount are displayed and a total amount held and a chart are displayed for each of virtual currencies (crypto assets). The footer menu FM11 is also always displayed on the home screen.

In contrast, when the “NFT” is selected in the tab T11, for example, a screen illustrated on the right side of FIG. 6 is displayed on the home screen.

In this example, information concerning an NFT in the total assets of the user is displayed on the home screen. Specifically, a total amount (in Japanese yen) of NFTs held by the user and a chart indicating increases and decreases in the total amount are displayed and images and the like showing the NFTs are displayed as a list.

Note that the switching of the display of the information concerning the crypto asset and the information concerning the NFT may be implemented by any operation such as slide operation (swipe operation) on a portion where the information is displayed or selection operation from a list without being limited to the operation on the tab T11.

In the examples illustrated in FIG. 5 and FIG. 6, since “total assets” is selected in the slide region R11, the information concerning the total assets of the user, that is, the information concerning both of the private bank account (the custodial wallet) and the public wallet is displayed on the home screen.

By performing the slide operation on the slide region R11, the user can easily select total assets or a wallet and switch the display of the home screen according to a result of the selection. That is, the user can easily switch information to be displayed.

In this case, the control unit 23 of the user terminal 11 updates information concerning the home screen in the display unit 22 based on a signal supplied from the input unit 21 according to operation on the slide region R11 of the user. In other words, the control unit 23 switches whether to cause information concerning an asset of the private bank account to be displayed on the home screen, information concerning an asset of the public wallet to be displayed on the home screen, or information concerning total assets of the private bank account and the public wallet to be displayed on the home screen.

For example, when one public wallet is selected by the slide operation on the slide region R11, the display of the home screen is switched to display of information concerning a crypto asset or an NFT held in the selected public wallet. That is, information concerning an asset held in the selected public wallet is displayed on the home screen.

Similarly, when the private bank account is selected by the slide operation on the slide region R11, information concerning an asset held in the private bank account such as a legal currency, a crypto asset, or an NFT held in the private bank account is displayed on the home screen.

Note that operation for switching the display on the home screen is not limited to the slide operation on the slide region R11 and may be any other operation.

In addition, here, an example in which the information concerning any one of the total assets, the private bank account, and the public wallet is displayed on the home screen according to the selection in the slide region R11 is explained. However, not only this, but the home screen may be any screen if the screen is capable of displaying respective kinds of information of the total assets, the private bank account, and the public wallet.

For example, on the home screen, information concerning a wallet (the private bank account or the public wallet) selected by the user may be displayed together with the information concerning the total assets or information concerning the total assets and all wallets may be always displayed.

With the home screen explained above, simply by performing the operation on the slide region R11, the user can easily cause desired information to be displayed.

As explained above, the footer menu FM11 is always (regularly) displayed on the display screen of the wallet application.

For that reason, simply by operating the home button BT11, the wallet button BT12, and the private bank account button BT13 provided in the footer menu FM11, the user can easily switch the display to the home screen, the public wallet screen, and the private bank account screen. Accordingly, it is possible to improve convenience.

Note that the switching of the display to the home screen and the public wallet screen may be implemented by any operation such as swipe operation on the display screen or selection operation from a wallet list without being limited to the operation on the footer menu FM11.

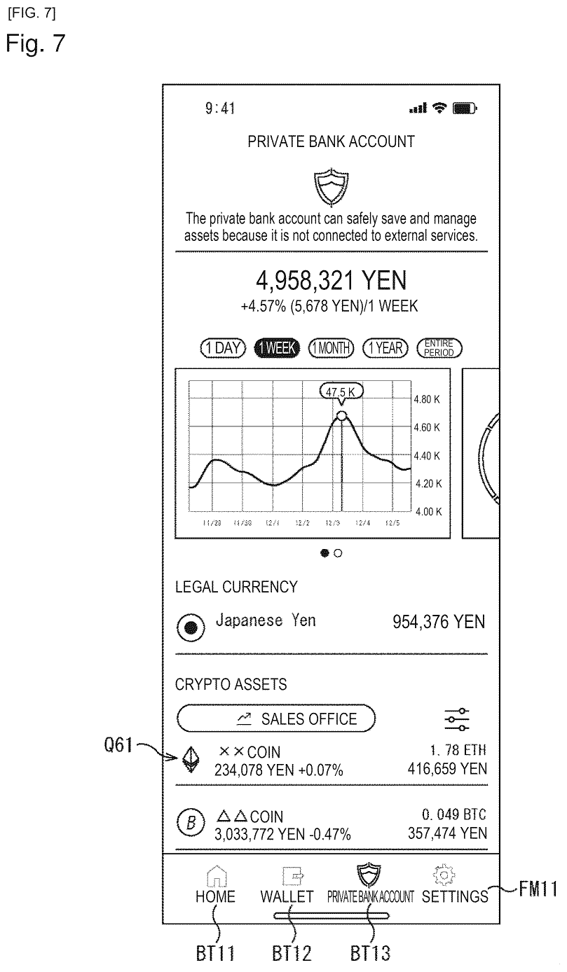

For example, in a state in which the private bank account screen is displayed as illustrated in FIG. 7, by selecting a desired virtual currency and performing necessary operation such as selection of a remittance destination, the user can easily perform remittance from the private bank account to the public wallet.

In an example illustrated in FIG. 7, information concerning a plurality of virtual currencies (crypto assets) held in the private bank account by the user is displayed side by side for each of the virtual currencies on the private bank account screen. Here, as the information concerning the virtual currencies, information such as a virtual currency name, an amount held of the virtual currencies (the crypto assets), and a converted amount into a legal currency is displayed.

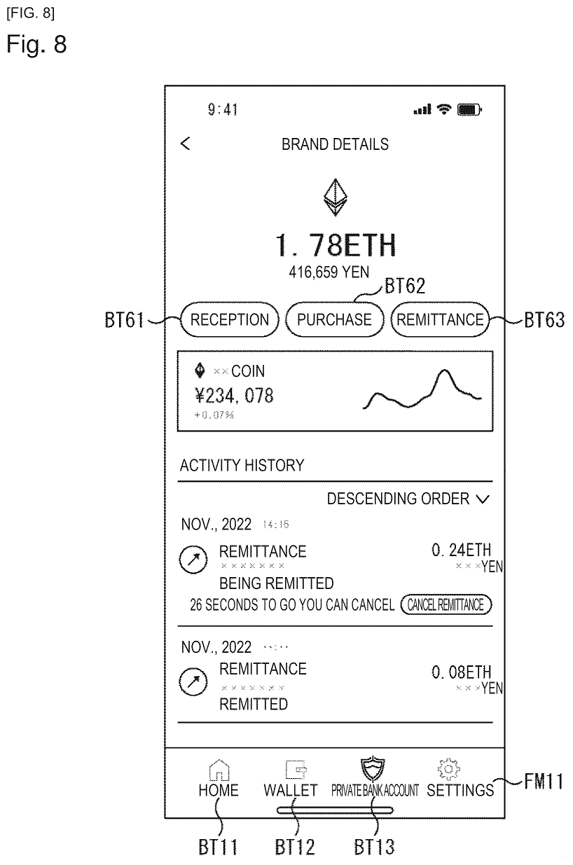

In such a case, for example, when the user operates a portion indicated by an arrow Q61, if a virtual currency displayed in the portion indicated by the arrow Q61 is selected, a screen for each of the virtual currencies illustrated in FIG. 8 is displayed.

On the screen illustrated in FIG. 8, information concerning the selected virtual currency is displayed and a reception button BT61, a purchase button BT62, and a remittance button BT63 are provided. Reception, purchase, remittance, and the like of a crypto asset can be performed.

In this example, as the information concerning the virtual currencies, information such as a virtual currency name, an amount held, a converted amount into a legal currency, and a remittance history of the virtual currencies (the crypto assets) is displayed.

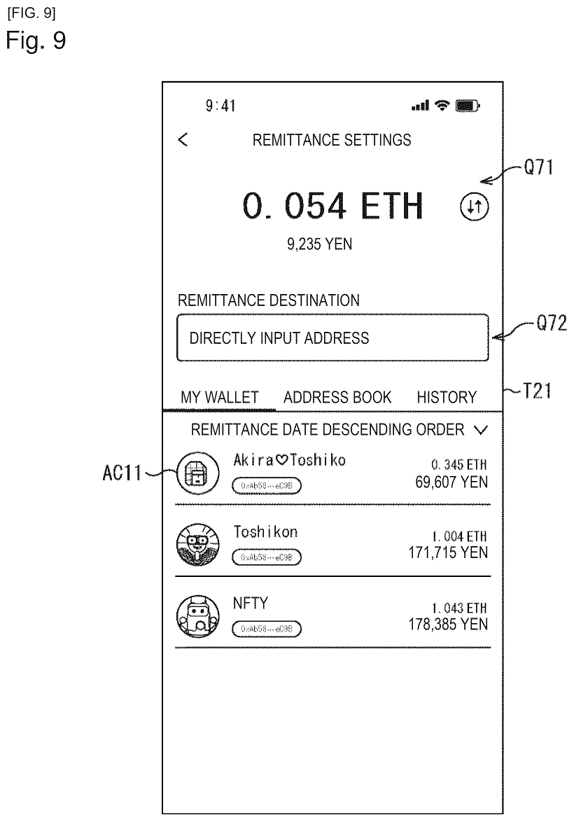

In a state in which the screen for each of the virtual currencies illustrated in FIG. 8 is displayed, when the user operates the remittance button BT63, for example, a remittance screen illustrated in FIG. 9 is popup-displayed.

On the remittance screen illustrated in FIG. 9, a remittance amount of a virtual currency (a crypto asset) from the private bank account is displayed in a portion indicated by an arrow Q71. By operating, for example, the portion where the remittance amount is displayed, the user can set (input) a desired remittance amount.

The user can designate a remittance destination by inputting an address of a remittance destination, that is, a wallet address (address information) of a wallet at the remittance destination in an input field provided in a portion indicated by an arrow Q72 or can also cause a wallet list to be displayed and designate a remittance destination.

A tab T21 is provided on the remittance screen. By selecting any one of “my wallet”, “address book”, and “history”, the user can cause information corresponding to the selection to be displayed in a portion on a lower side in the figure of the tab T21.

In this example, the “my wallet” is selected and, therefore, a list of public wallets held by the user is displayed as the wallet list. The wallet list is a list of one or a plurality of public wallets that are candidates of a remittance destination.

In item fields of the wallet list, information concerning the public wallets held by the user is displayed. Specifically, for example, in one item field, for one public wallet, information such as an account name, the icon image AC11 representing an account, address information of the public wallet, and an amount held of a virtual currency held in the public wallet is displayed.

By selecting an item field of a desired public wallet from the wallet list displayed as explained above, the user can select, as a remittance destination, a public wallet corresponding to the item field. By causing the wallet list to be displayed as explained above, the user can easily perform remittance from the private bank account of the user to the public wallet of the user.

In addition, when the “address book” is selected in the tab T21, a list of wallets registered in advance as candidates of a remittance destination is displayed as an address book on the remittance screen. For example, wallets of other persons other than the user can be registered in the address book. The user can also select, from the address book, a wallets set as a remittance destination.

Further, when the “history” is selected in the tab T21, a list of remittance histories in the past is displayed on the remittance screen.

For example, when the user performs operation of instructing remittance (remittance instruction operation) on the remittance screen, remittance processing may not be immediately performed and actual remittance processing may be performed after a predetermined time has elapsed, for example, thirty seconds after the remittance instruction operation was performed.

In such a case, for example, in a portion of a list of remittance histories on the remittance screen, a remittance history (a transaction) corresponding to the remittance instruction operation is displayed together with a pending mark indicating that remittance is on hold. When the user desires to stop remittance instructed once, the user can select the remittance history and instruct remittance stop while the pending mark is displayed. Accordingly, within the predetermined time, the user can stop (cancel) remittance due to erroneous operation or the like. Accordingly, it is possible to improve convenience.

Note that, here, an example in which the remittance from the private bank account of the user to the public wallet of the user is performed is explained. However, remittance between public wallets of the user and remittance from the public wallet to the private bank account of the user can be easily performed in the same manner.

In the user terminal 11, account information of the private bank account of the user and address information of the one or the plurality of public wallets of the user are linked and recorded in advance. That is, the private bank account and the public wallets are seamlessly connected (associated).

Therefore, in the user terminal 11, for example, remittance between wallets of the user, which has originally been complicated, such as remittance from the private bank account to the public wallet can be easily performed. Similarly, purchase, trade, and the like of an NFT can also be easily performed. Accordingly, it is possible to improve convenience.

In addition, as explained above, the menu button MN11 and the switching button BT21 for switching the public wallet are provided on the public wallet screen.

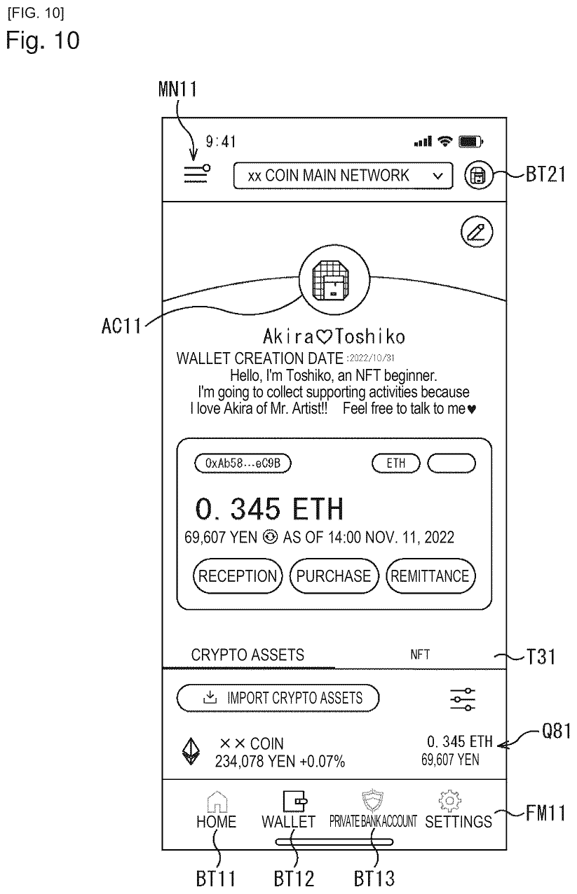

Further, on the public wallet screen, for example, as illustrated in FIG. 10, a tab T31 for switching whether to cause information concerning a crypto currency held in the public wallet to be displayed or information concerning an NFT to be displayed is also provided.

For example, when “crypto asset” is selected in the tab T31, in a portion indicated by an arrow Q81 on the public wallet screen, information concerning a crypto asset held in the public wallet by the user is displayed.

In this example, information such as a total amount of crypto assets held by the user, a converted amount obtained by converting the total amount into a legal currency (Japanese yen), and increase or decrease of the converted amount is displayed for each of virtual currencies (crypto assets).

In contrast, for example, when “NFT” is selected in the tab T31, in the portion indicated by the arrow Q81 on the public wallet screen, information concerning an NFT (NFT information) held in the public wallet illustrated in FIG. 4 is displayed.

In addition, for example, by operating the menu button MN11, the user can instruct execution of, for example, processing in which a selected-state public wallet is used.

As a specific example, it is assumed that the user operates the menu button MN11 to select a Web site that provides a predetermined service and instruct connection to the Web site.

In such a case, for example, when a signal corresponding to operation of the user is supplied from the input unit 21, the control unit 23 of the user terminal 11 connects to (accesses), based on information concerning the selected-state public wallet recorded in the recording unit 25, using the public wallet, the Web site designated by the user. In other words, the control unit 23 controls the communication unit 24 to connect to a service designated by the user with the selected-state public wallet, more specifically, a server providing the service and causes a screen concerning the service to be displayed with a browser or the like. The information concerning the public wallet referred to herein is, for example, account information and address information.

Besides, for example, the control unit 23 may control the communication unit 24 based on the information concerning the public wallet to perform processing of connecting to, with the selected-state public wallet, a site (a service) searched by the user, for example, on the display screen of the wallet application.

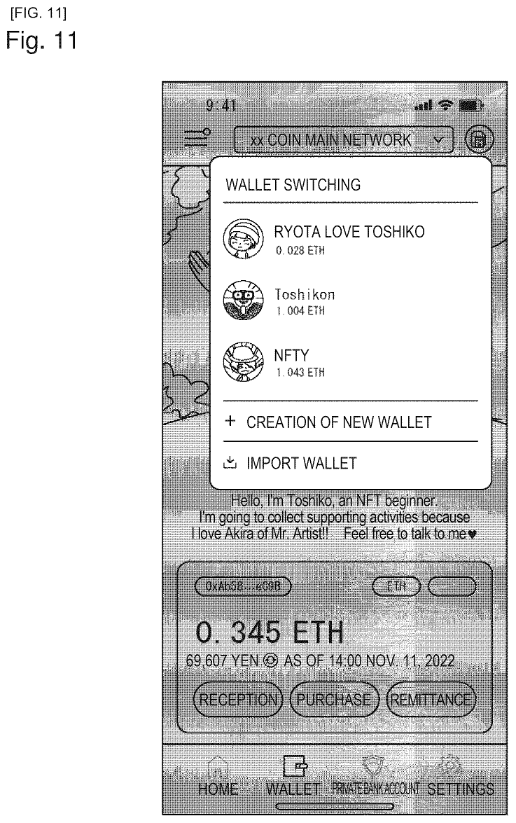

For example, when the user operates the switching button BT21 provided on the public wallet screen, for example, a wallet switching screen illustrated in FIG. 11 is popup-displayed.

A plurality of public wallets usable by the user are displayed as a list on the wallet switching screen illustrated in FIG. 11.

In this example, in fields of public wallets, account names, icon images such as PFPs, and amounts held of crypto assets in public wallets are displayed. The user can easily grasp which public wallet is selected when the user selects which field.

By selecting a desired public wallet on the wallet switching screen, the user can easily switch a public wallet to be used, that is, an account as in account switching operation of an SNS (Social Networking Service) or the like. In this case, when a public wallet is selected, a public wallet screen of the selected public wallet is displayed.

In addition, on the wallet switching screen, a wallet creation button for creating a new public wallet and an import button for importing a public wallet are also provided.

Therefore, for example, by operating the wallet creation button, the user can create a plurality of public wallets according to purposes of use such as services in the metaverse, Web 3.0, or the like that the user desires to use and easily use the public wallets depending on purposes.

According to the examples illustrated in FIG. 2 to FIG. 11 above, it is possible to seamlessly connect (associate) the private bank account and the public wallets and easily perform remittance between wallets, purchase of an NFT, trade of the NFT, and the like. Accordingly, it is possible to improve convenience.

### Explanation of Display Processing

Subsequently, processing performed by the user terminal 11 is explained.

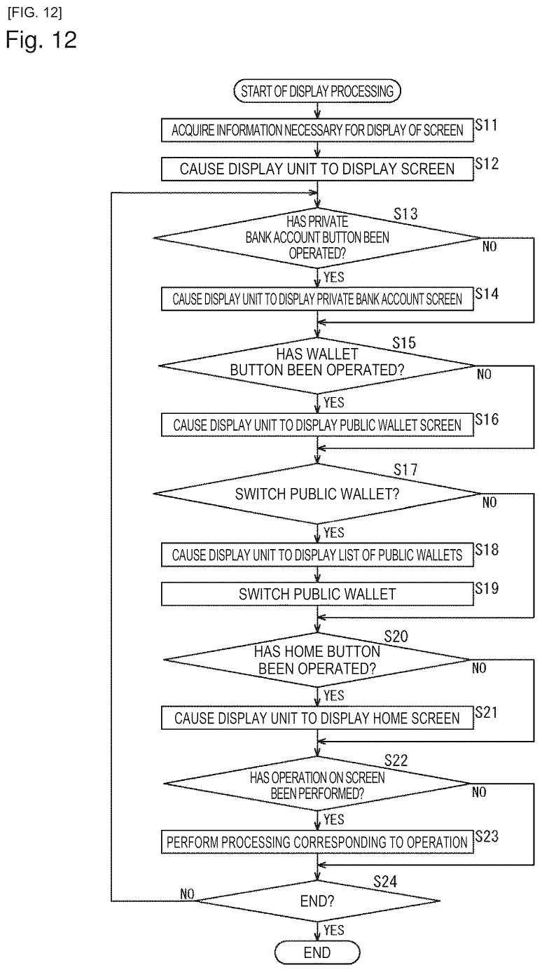

For example, when the user operates the input unit 21 of the user terminal 11 and instructs start of the wallet application, the control unit 23 reads a program from the recording unit 25 and executes the program and starts the wallet application. At this time, the user terminal 11 performs, for example, display processing illustrated in FIG. 12.

The display processing by the user terminal 11 is explained below with reference to a flowchart of FIG. 12.

In step S11, the control unit 23 acquires, from the recording unit 25 and an external device such as the server 12, information necessary for displaying a screen.

The information necessary for displaying a screen referred to herein is, for example, information concerning a private bank account and information concerning a public wallet necessary for displaying a screen of a wallet application, that is, a home screen, a private bank account screen, and a public wallet screen.

For example, the control unit 23 accesses the server 12 with the communication unit 24 based on the account information of the private bank account and the connection destination information recorded in the recording unit 25 and performs login. Then, the control unit 23 transmits, with the communication unit 24, to the server 12, a transmission request for requesting transmission of information concerning the private bank account of the user.

When receiving the transmission request from the user terminal 11 with the communication unit 41, the control unit 43 of the server 12 collects information corresponding to the transmission request.

Specifically, for example, the control unit 43 reads the private bank account of the user, that is, address information of a custodial wallet from the recording unit 42. If information concerning the private bank account such as the balance of a legal currency of the private bank account, metadata and media data of an NFT, and the like is present in the recording unit 42, the control unit 43 reads the information from the recording unit 42 as well.

Further, the control unit 43 reads, based on the address information of the custodial wallet, with the communication unit 41, information concerning an asset held in the private bank account (the custodial wallet) of the user from a centralized management type database or a blockchain (a private chain).

The information concerning the asset held in the private bank account referred to herein is, for example, a type and the balance of a legal currency managed (held) in the private bank account, a type and the balance (an amount held) of a crypto asset, NFT information, and the like.

The control unit 43 supplies the address information of the private bank account, the information concerning the asset held in the private bank account, and the like read as explained above to the communication unit 41 as information concerning the private bank account of the user and causes the communication unit 41 to transmit the information concerning the private bank account to the user terminal 11.

The control unit 23 of the user terminal 11 controls the communication unit 24 to receive the information concerning the private bank account transmitted from the server 12 to acquire (collect) the information concerning the private bank account of the user and supplies the acquired information to the recording unit 25 and causes the recording unit 25 to record the acquired information according to necessity.

At this time, for example, the control unit 23 may cause the address information of the private bank account to be recorded in association with the account information of the private bank account.

Accordingly, in the recording unit 25, the address information and the account information of the private bank account and the account information and the address information of the one or the plurality of public wallets can be linked. Therefore, the user can perform switching to the private bank account and the public wallet with simple operation. Accordingly, it is possible to improve convenience.

Note that, in the recording unit 25, the address information of the private bank account and the address information of the one or the plurality of public wallets may be linked with each other and recorded in advance.

For example, the control unit 23 acquires information concerning the public wallets as well.

Specifically, the control unit 23 reads the address information of the public wallets of the user from the recording unit 25. Then, the control unit 23 reads, based on the read address information of the public wallets, with the communication unit 24, from the blockchain (the public chain), information concerning an asset held in the public wallet of the user, supplies the information to the recording unit 25, and causes the recording unit 25 to record the information. The information concerning the asset held in the public wallet referred to herein is, for example, a type and the balance (an amount held) of a crypto asset and NFT information.

Note that a part or all of the information concerning the public wallets may not be directly acquired from the public chain by the user terminal 11 but may be acquired from the public chain or the like by an external device such as the server 12. In such a case, the control unit 23 of the user terminal 11 acquires a part or all of the information concerning the public wallets with the communication unit 24 from the external device such as the server 12.

In addition, among the information concerning the private bank account and the information concerning the public wallets, information other than information required in the processing in step S12 may not be acquired in step S11 and may be acquired at timing when the information is required in display of a screen designated by the user.

In step S12, the control unit 23 controls the display unit 22 based on the information acquired in step S11 and information concerning the private bank account and the public wallets recorded in the recording unit 25 in advance and causes the display unit 22 to display the screen of the wallet application.

Specifically, for example, the control unit 23 generates, based on, for example, the information acquired in step S11, image data for causing a home screen to be displayed. Then, the control unit 23 supplies the generated image data to the display unit 22 and causes a home screen to be displayed based on the image data. Accordingly, for example, the home screen illustrated in FIG. 5 or FIG. 6 is displayed on the display unit 22.

When the home screen is displayed, thereafter, the user operates the input unit 21 as appropriate to perform operation on the displayed screen of the wallet application such as the home screen and instructs display of a desired screen or instructs execution of desired processing.

Specifically, the user can switch display, for example, by operating a home button, a wallet button, or a private bank account button on a footer menu always displayed on the screen of the wallet application. Note that, here, an example in which the home screen is displayed as the screen of the wallet application in step S12 is explained. However, a private bank account screen and a public wallet screen may be displayed.

In step S13, the control unit 23 determines, based on a signal supplied from the input unit 21 according to operation of the user, whether the private bank account button of the footer menu has been operated by the user, that is, switching of display to the private bank account screen has been instructed.

When it is determined in step S13 that the private bank account button has been operated, thereafter, the processing proceeds to step S14.

In step S14, the control unit 23 controls the display unit 22 based on the information acquired in step S11 and the information concerning the private bank account recorded in the recording unit 25 in advance and causes the display unit 22 to display the private bank account screen. Then, the control unit 23 selects, as a wallet used by the user, a custodial wallet corresponding to the private bank account. Accordingly, for example, the private bank account screen illustrated in FIG. 2 is displayed.

When the private bank account screen has been displayed in step S14 or it is determined in step S13 that the private bank account button has not been operated, thereafter, processing in step S15 is performed.

In step S15, the control unit 23 determines, based on a signal supplied from the input unit 21 according to operation of the user, whether the wallet button of the footer menu has been operated by the user, that is, switching of display to the public wallet screen has been instructed.

When it is determined in step S15 that the wallet button has been operated, thereafter, the processing proceeds to step S16.

In step S16, the control unit 23 controls the display unit 22 based on the information acquired in step S11 and the information concerning the public wallets recorded in the recording unit 25 in advance and causes the display unit 22 to display the public wallet screen. Accordingly, for example, the public wallet screen illustrated in FIG. 3 is displayed.

In addition, the control unit 23 selects a public wallet as the wallet to be used by the user. That is, the wallet to be used is switched to the public wallet.

At this time, the public wallet to be selected is, for example, a public wallet selected at the present point in time, that is, a public wallet selected last on the wallet switching screen illustrated in FIG. 11 but may be, for example, a public wallet designated in default.

When the public wallet screen has been displayed in step S16 or it is determined in step S15 that the wallet button has not been operated, thereafter, processing in step S17 is performed.

In step S17, the control unit 23 determines whether to switch the public wallet.

In step S17, for example, the public wallet screen illustrated in FIG. 3 or FIG. 10 is displayed on the display unit 22. When the switching button BT21 on the public wallet screen is operated by the user, it is determined that the public wallet is switched.

When it is determined in step S17 that the public wallet is switched, thereafter, processing in step S18 and step S19 is performed.

In step S18 and step S19, the control unit 23 performs processing of causing information concerning a public wallet selected according to operation on the switching button by the user to be displayed on the public wallet screen.

That is, in step S18, the control unit 23 controls the display unit 22 based on the information concerning the public wallet recorded in the recording unit 25 in advance and causes the display unit 22 to display a list of public wallets.

Specifically, for example, the wallet switching screen illustrated in FIG. 11 is displayed as the list of the public wallets.

The user selects a public wallet to be used out of the displayed wallet switching screen, that is, the list of the public wallets.

In step S19, the control unit 23 switches the public wallet based on a signal supplied from the input unit 21 according to selection operation of the user. That is, the control unit 23 switches the wallet to be used to the public wallet selected by the user.

In addition, the control unit 23 updates the display of the public wallet screen on the display unit 22 such that information concerning the public wallet after the switching is displayed. That is, the control unit 23 causes a public wallet screen of the public wallet after the switching to be displayed.

When it is determined in step S19 that the public wallet has been switched or it is determined in step S17 that the public wallet is not switched, thereafter, processing in step S20 is performed.

In step S20, the control unit 23 determines, based on a signal supplied from the input unit 21 according to operation of the user, whether the home button of the footer menu has been operated by the user, that is, switching of display to the home screen has been instructed.

When it is determined in step S20 that the home button has been operated, thereafter, the processing proceeds to step S21.

In step S21, the control unit 23 controls the display unit 22 based on the information acquired in step S11 and the information concerning the private bank account and the information concerning the public wallets recorded in the recording unit 25 in advance and causes the display unit 22 to display a home screen.

Accordingly, for example, the home screen illustrated in FIG. 5 or FIG. 6 is displayed.

In addition for example, in a state in which the home screen illustrated in FIG. 5 is displayed, when the user performs operation (slide operation) on the slide region R11, the control unit 23 updates (switches) the display of the home screen according to the operation on the slide region R11 by the user.

That is, the control unit 23 causes, based on the information acquired in step S11 and the information concerning the private bank account and the information concerning the public wallets recorded in the recording unit 25 in advance, information corresponding to the operation of the user to be displayed on the home screen. Accordingly, as explained with reference to FIG. 5 and FIG. 6, any of the information concerning the total assets, the information concerning the private bank account, and the information concerning the selected public wallet is displayed on the home screen.

Further, for example, when operation on the tab T11 on the home screen illustrated in FIG. 5 is performed by the user, the control unit 23 also performs switching of display corresponding to the operation. That is, the control unit 23 switches, according to the operation on the tab T11 by the user, whether to cause information concerning a crypto asset to be displayed on the home screen or to cause information concerning an NET to be displayed on the home screen. Specifically, for example, whether the screen illustrated on the right side of FIG. 6 is displayed or the screen illustrated on the left side of FIG. 6 is displayed is switched.

As explained above, the control unit 23 switches, according to the operation of the user on the footer menu, the display of the home screen, the private bank account screen, and the public wallet screen. That is, the display is switched to any one screen of the home screen, the private bank account screen, and the public wallet screen.

At this time, the switching of the display is performed based on the information acquired in step S11, information concerning the private bank account recorded in the recording unit 25 in advance such as the account information of the private bank account, and information concerning the public wallets recorded in the recording unit 25 in advance such as the address information of the public wallets.

When the home screen has been displayed in step S21 or it is determined in step S20 that the home button has not been operated, thereafter, processing in step S22 is performed.

In step S22, the control unit 23 determines, based on a signal supplied from the input unit 21 according to operation of the user, whether other operations on the display screen of the wallet application have been performed by the user. The other operations referred to herein are operations other than the operation on the footer menu and the operation of the switching button for the public wallet explained above.

When determining in step S22 that the other operations have been performed, in step S23, the control unit 23 performs processing corresponding to the operations of the user.

As a specific example, in a state in which the private bank account screen illustrated in FIG. 7 is displayed, when the user performs operation of designating a predetermined crypto asset (virtual currency), the control unit 23 causes, according to the designation operation of the user, a screen for each virtual currency designated by the user to be displayed. Accordingly, for example, the screen illustrated in FIG. 8 is displayed.

In addition, when the user operates a remittance button BT63 on the screen for each virtual currency illustrated in FIG. 8, the control unit 23 causes a remittance screen to be popup-displayed on the display unit 22. Accordingly, for example, the remittance screen illustrated in FIG. 9 is displayed.

Further, when the user selects a remittance amount and a public wallet at a remittance destination on the remittance screen, the control unit 23 performs remittance processing of remitting the crypto asset by the remittance amount designated by the user from the private bank account of the user to the public wallet selected by the user.

At this time, the control unit 23 causes, for example, the wallet list illustrated in FIG. 9 to be displayed, and the user selects a wallet at a remittance destination from the displayed wallet list. Here, it is assumed that, for example, a public wallet of the user is selected as the remittance destination.

For example, in the remittance processing, while communicating with the server 12 through the communication unit 24 according to necessity based on address information of the private bank account and address information of the public wallet, the control unit 23 requests the server 12 to issue a transaction for performing remittance for the remittance amount from the private bank account to the public wallet.

The control unit 43 of the server 12 issues (generates) a transaction according to the request from the user terminal 11, transmits the transaction to a smart contract or the like with the communication unit 41, and causes the smart contract or the like to record the transaction in the blockchain.

In this case, in the transaction, for example, information indicating the private bank account (the custodial wallet) that is a remittance source, information indicating the public wallet that is a remittance destination, information indicating a virtual currency to be remitted and a remittance amount, and the like are stored. Here, the information indicating the remittance source and the remittance destination is, for example, address information.

Note that the issuance of the transaction and the transmission of the transaction to the smart contract and the like may be performed by the server 12 or may be performed by the user terminal 11.

In addition, more specifically, the control unit 23 executes the remittance processing after a predetermined time has elapsed since the instruction for the remittance by the user was made (the execution of the remittance was instructed). In this case, when operation of cancelling (stopping) the remittance is performed by the user before the execution of the remittance processing, that is, before the predetermined time elapses, the control unit 23 cancels the remittance of the crypto asset without executing the remittance processing.

Besides, for example, when the user instructs the switching of the display to the home screen, the public wallet screen, and the private bank account screen with other operations different from the operation on the footer menu, the control unit 23 controls the display unit 22 to display the instructed screen.

When the processing corresponding to the operation of the user has been performed in step S23 or when it is determined in step S22 that the other operations have not been performed, thereafter, processing in step S24 is performed.

In step S24, the control unit 23 determines, based on a signal supplied from the input unit 21 according to operation of the user, whether to end the wallet application, that is, whether the end of the wallet application has been instructed by the user.

When it is not determined in step S24 to end the wallet application, thereafter, the processing returns to step S13 and the processing explained above is repeatedly performed.

In contrast, when it is determined in step S24 to end the wallet application, the control unit 23 ends the processing concerning the wallet application.

Accordingly, the display processing also ends.

As explained above, based on the account information and the address information of the private bank account and the account information and the address information of the one or the plurality of public wallets linked with each other, the user terminal 11 displays the screen of the wallet application and performs switching of the wallet, the update of the display, the remittance processing, and the like according to operation of the user.

Accordingly, it is possible to seamlessly associate the private bank account and the public wallets to easily perform switching of the display screen (the wallet), remittance between wallets, and the like and improve convenience.

### Configuration Example of a Computer

Incidentally, the series of processing explained above can also be executed by hardware or can also be executed by software. When the series of processing is executed by software, a program constituting the software is installed in a computer. Here, the computer includes a computer incorporated in dedicated hardware or, for example, a general-purpose personal computer capable of executing various functions by installing various programs.

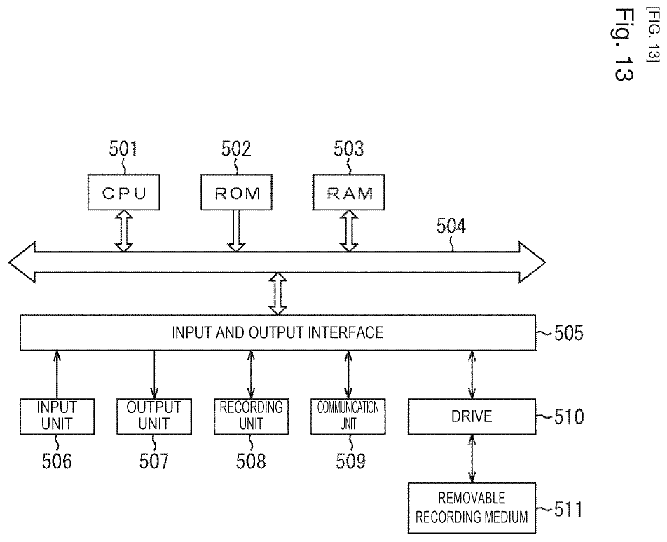

FIG. 13 is a block diagram illustrating a configuration example of hardware of the computer that executes the series of processing explained above according to the program.

In the computer, a CPU (Central Processing Unit) 501, a ROM (Read Only Memory) 502, and a RAM (Random Access Memory) 503 are connected to one another by a bus 504.

Further, an input and output interface 505 is connected to the bus 504. An input unit 506, an output unit 507, a recording unit 508, a communication unit 509, and a drive 510 are connected to the input and output interface 505.

The input unit 506 includes a keyboard, a mouse, a microphone, and an imaging element and the like. The output unit 507 includes a display and a speaker and the like. The recording unit 508 includes a hard disk and a nonvolatile memory and the like. The communication unit 509 includes a network interface and the like. The drive 510 drives a removable recording medium 511 such as a magnetic disk, an optical disk, a magneto-optical disk, or a semiconductor memory.

In the computer configured as explained above, the CPU 501 loads, for example, a program recorded in the recording unit 508 to the RAM 503 via the input and output interface 505 and the bus 504, and executes the program, whereby the series of processing explained above is performed.

The program to be executed by the computer (the CPU 501) can be provided by, for example, being recorded in the removable recording medium 511 serving as a package medium or the like. The program can be provided via a wired or wireless transmission medium such as a local area network, the Internet, or digital satellite broadcast.

In the computer, the program can be installed in the recording unit 508 via the input and output interface 505 by inserting the removable recording medium 511 into the drive 510. In addition, the program can be received by the communication unit 509 via a wired or wireless transmission medium and installed in the recording unit 508. Besides, the program can be installed in advance in the ROM 502 and the recording unit 508.

Note that the program to be executed by the computer may be a program according to which processing is performed in time series in the order explained in the present specification or may be a program according to which processing is performed in parallel, or at necessary timings such as times when the program is invoked.

Embodiments of the present technology are not limited to the embodiment explained above and various changes are possible in a range not departing from the gist of the present technology.

For example, the present technology can adopt a configuration of cloud computing in which a plurality of devices share one function via a network and jointly process the function.

In addition, the steps explained in the flowchart explained above can be shared and executed by a plurality of devices besides being executed by one device.

Further, when a plurality of kinds of processing are included in one step, the plurality of kinds of processing included in the one step can be shared and executed by a plurality of devices besides being executed by one device.

Further, the present technology can also take the following configurations.
(1)

An information processing device including:
a recording unit that links account information of one or a plurality of private bank accounts of a user with address information of one or a plurality of noncustodial wallets of the user and records the account information and the address information; and
a control unit that switches, based on the account information and the address information, according to operation of the user, display of a private bank account screen on which information concerning the private bank account is displayed, a wallet screen on which information concerning the noncustodial wallet is displayed, and a home screen on which information concerning the one or the plurality of private bank accounts and information concerning the one or the plurality of noncustodial wallets can be displayed.
(2)

The information processing device described in (1), wherein the control unit always displays a predetermined display region and switches the display according to operation on the display region by the user.
(3)

The information processing device described in (2), wherein, in the display region, a button for displaying the private bank account screen, a button for displaying the wallet screen, and a button for displaying the home screen are provided.
(4)

The information processing device described in any one of (1) to (3), wherein the private bank account is managed by a custodial wallet.
(5)

The information processing device described in any one of (1) to (4), wherein an icon image corresponding to the noncustodial wallet is displayed on the wallet screen.
(6)

The information processing device described in (5), wherein the icon image is an image of a character.
(7)

The information processing device described in any one of (1) to (6), wherein the control unit switches, according to operation on the home screen by the user, whether to display information concerning an asset of the private bank account on the home screen, display information concerning an asset of the noncustodial wallet on the home screen, or display information concerning total assets of the private bank account and the noncustodial wallet on the home screen.
(8)

The information processing device described in any one of (1) to (7), wherein the control unit performs, according to operation on the private bank account screen by the user, processing for remitting an asset from the private bank account to the noncustodial wallet based on the address information.
(9)

The information processing device described in (8), wherein, after a predetermined time has elapsed since an instruction for remittance by the user was made, the control unit executes processing for remitting the asset.
(10)

The information processing device described in (9), wherein, when operation of cancelling the remittance of the asset is performed by the user before the predetermined time elapses, the control unit does not execute the processing for remitting the asset.
(11)

The information processing device described in any one of (8) to (10), wherein the control unit displays a list of one or a plurality of the noncustodial wallets that are candidates of a remittance destination of an asset of the private bank account.
(12)

The information processing device described in any one of (1) to (11), wherein
a switching button for switching the noncustodial wallet is provided on the wallet screen, and
the control unit displays, on the wallet screen, information concerning the noncustodial wallet selected according to operation on the switching button.
(13)

The information processing device described in (12), wherein the control unit displays a list of the one or the plurality of noncustodial wallets according to operation on the switching button.
(14)

The information processing device described in any one of (1) to (13), wherein the private bank account is an identity-verified bank account.
(15)

An information processing method including a step of an information processing device switching, based on account information of one or a plurality of private bank accounts of a user and address information of one or a plurality of noncustodial wallets of the user, the account information and the address information being linked with each other and recorded, according to operation of the user, display of a private bank account screen on which information concerning the private bank account is displayed, a wallet screen on which information concerning the noncustodial wallet is displayed, and a home screen on which information concerning the one or the plurality of private bank accounts and information concerning the one or the plurality of noncustodial wallets can be displayed.
(16)

A program for causing a computer to execute processing including a step of switching, based on account information of one or a plurality of private bank accounts of a user and address information of one or a plurality of noncustodial wallets of the user, the account information and the address information being linked with each other and recorded, according to operation of the user, display of a private bank account screen on which information concerning the private bank account is displayed, a wallet screen on which information concerning the noncustodial wallet is displayed, and a home screen on which information concerning the one or the plurality of private bank accounts and information concerning the one or the plurality of noncustodial wallets can be displayed.
(17)

An information processing device including a control unit that, based on account information of one or a plurality of private bank accounts of a user and address information of one or a plurality of noncustodial wallets of the user, the account information and the address information being linked with each other and recorded, displays a home screen on which information concerning the one or the plurality of private bank accounts and information concerning the one or the plurality of noncustodial wallets can be displayed and switches, according to operation of the user, whether to display information concerning one of the private bank accounts on the home screen, display information concerning one of the noncustodial wallets on the home screen, or display information concerning total assets of the private bank account and the noncustodial wallet on the home screen.
(18)

An information processing method including a step of an information processing device, based on account information of one or a plurality of private bank accounts of a user and address information of one or a plurality of noncustodial wallets of the user, the account information and the address information being linked with each other and recorded, displaying a home screen on which information concerning the one or the plurality of private bank accounts and information concerning the one or the plurality of noncustodial wallets can be displayed and switching, according to operation of the user, whether to display information concerning one of the private bank accounts on the home screen, display information concerning one of the noncustodial wallets on the home screen, or display information concerning total assets of the private bank account and the noncustodial wallet on the home screen.
(19)

A program for causing a computer to execute processing including a step of, based on account information of one or a plurality of private bank accounts of a user and address information of one or a plurality of noncustodial wallets of the user, the account information and the address information being linked with each other and recorded, displaying a home screen on which information concerning the one or the plurality of private bank accounts and information concerning the one or the plurality of noncustodial wallets can be displayed and switching, according to operation of the user, whether to display information concerning one of the private bank accounts on the home screen, display information concerning one of the noncustodial wallets on the home screen, or display information concerning total assets of the private bank accounts and the noncustodial wallets on the home screen.

### REFERENCE SIGNS LIST

11 User terminal, 12 Server, 21 Input unit, 22 Display unit, 23 Control unit, 24 Communication unit, 25 Recording unit, 41 Communication unit, 42 Recording unit, 43 Control unit

1. An information processing device comprising:
a recording unit that links account information of one or a plurality of private bank accounts of a user with address information of one or a plurality of noncustodial wallets of the user and records the account information and the address information; and
a control unit that switches, based on the account information and the address information, according to operation of the user, display of a private bank account screen on which information concerning the private bank account is displayed, a wallet screen on which information concerning the noncustodial wallet is displayed, and a home screen on which information concerning the one or the plurality of private bank accounts and information concerning the one or the plurality of noncustodial wallets can be displayed.

2. The information processing device according to claim 1, wherein the control unit always displays a predetermined display region and switches the display according to operation on the display region by the user.

3. The information processing device according to claim 2, wherein, in the display region, a button for displaying the private bank account screen, a button for displaying the wallet screen, and a button for displaying the home screen are provided.

4. The information processing device according to claim 1, wherein the private bank account is managed by a custodial wallet.

5. The information processing device according to claim 1, wherein an icon image corresponding to the noncustodial wallet is displayed on the wallet screen.

6. The information processing device according to claim 5, wherein the icon image is an image of a character.

7. The information processing device according to claim 1, wherein the control unit switches, according to operation on the home screen by the user, whether to display information concerning an asset of the private bank account on the home screen, display information concerning an asset of the noncustodial wallet on the home screen, or display information concerning total assets of the private bank account and the noncustodial wallet on the home screen.

8. The information processing device according to claim 1, wherein the control unit performs, according to operation on the private bank account screen by the user, processing for remitting an asset from the private bank account to the noncustodial wallet based on the address information.

9. The information processing device according to claim 8, wherein, after a predetermined time has elapsed since an instruction for remittance by the user was made, the control unit executes processing for remitting the asset.

10. The information processing device according to claim 9, wherein, when operation of cancelling the remittance of the asset is performed by the user before the predetermined time elapses, the control unit does not execute the processing for remitting the asset.

11. The information processing device according to claim 8, wherein the control unit displays a list of one or a plurality of the noncustodial wallets that are candidates of a remittance destination of an asset of the private bank account.

12. The information processing device according to claim 1, wherein
a switching button for switching the noncustodial wallet is provided on the wallet screen, and
the control unit displays, on the wallet screen, information concerning the noncustodial wallet selected according to operation on the switching button.

13. The information processing device according to claim 12, wherein the control unit displays a list of the one or the plurality of noncustodial wallets according to operation on the switching button.

14. The information processing device according to claim 1, wherein the private bank account is an identity-verified bank account.

15. An information processing method comprising a step of an information processing device switching, based on account information of one or a plurality of private bank accounts of a user and address information of one or a plurality of noncustodial wallets of the user, the account information and the address information being linked with each other and recorded, according to operation of the user, display of a private bank account screen on which information concerning the private bank account is displayed, a wallet screen on which information concerning the noncustodial wallet is displayed, and a home screen on which information concerning the one or the plurality of private bank accounts and information concerning the one or the plurality of noncustodial wallets can be displayed.

16. A program for causing a computer to execute processing comprising a step of switching, based on account information of one or a plurality of private bank accounts of a user and address information of one or a plurality of noncustodial wallets of the user, the account information and the address information being linked with each other and recorded, according to operation of the user, display of a private bank account screen on which information concerning the private bank account is displayed, a wallet screen on which information concerning the noncustodial wallet is displayed, and a home screen on which information concerning the one or the plurality of private bank accounts and information concerning the one or the plurality of noncustodial wallets can be displayed.

17. An information processing device comprising a control unit that, based on account information of one or a plurality of private bank accounts of a user and address information of one or a plurality of noncustodial wallets of the user, the account information and the address information being linked with each other and recorded, displays a home screen on which information concerning the one or the plurality of private bank accounts and information concerning the one or the plurality of noncustodial wallets can be displayed and switches, according to operation of the user, whether to display information concerning one of the private bank accounts on the home screen, display information concerning one of the noncustodial wallets on the home screen, or display information concerning total assets of the private bank account and the noncustodial wallet on the home screen.

18. An information processing method comprising a step of an information processing device, based on account information of one or a plurality of private bank accounts of a user and address information of one or a plurality of noncustodial wallets of the user, the account information and the address information being linked with each other and recorded, displaying a home screen on which information concerning the one or the plurality of private bank accounts and information concerning the one or the plurality of noncustodial wallets can be displayed and switching, according to operation of the user, whether to display information concerning one of the private bank accounts on the home screen, display information concerning one of the noncustodial wallets on the home screen, or display information concerning total assets of the private bank account and the noncustodial wallet on the home screen.

19. A program for causing a computer to execute processing including a step of, based on account information of one or a plurality of private bank accounts of a user and address information of one or a plurality of noncustodial wallets of the user, the account information and the address information being linked with each other and recorded, displaying a home screen on which information concerning the one or the plurality of private bank accounts and information concerning the one or the plurality of noncustodial wallets can be displayed and switching, according to operation of the user, whether to display information concerning one of the private bank accounts on the home screen, display information concerning one of the noncustodial wallets on the home screen, or display information concerning total assets of the private bank accounts and the noncustodial wallets on the home screen.
